(19) United States
(12) Patent Application Publication
(10) Pub. No.: US 2013/0025987 A1
(43) Pub. Date: Jan. 31, 2013

(54) METHODS AND APPARATUS FOR CONTROLLING A FLUID DAMPER

(71) Applicant: David Batterbee, Santa Cruz, CA (US)

(72) Inventor: David Batterbee, Santa Cruz, CA (US)

(21) Appl. No.: 13/552,562

(22) Filed: Jul. 18, 2012

Related U.S. Application Data
(60) Provisional application No. 61/508,755, filed on Jul. 18, 2011.

(51) Int. Cl. F16F 9/19; F16F 9/53

(52) U.S. Cl. 188/267.2

(57) ABSTRACT

A fluid damper includes a fluid filled chamber, the fluid comprising a variable rheological fluid, and a barrier separating the chamber into a first and second side. The barrier includes at least one fluid flow path therethrough, and the barrier further includes at least one seal assembly for selectively sealing the fluid path in a first direction. The seal assembly includes a sealing member that has at least one non-metallic sealing surface.

### CROSS-REFERENCE TO RELATED APPLICATIONS

This application claims priority to and benefit of U.S. provisional patent application Ser. No. 61/508,755, filed Jul. 18, 2011, which is herein incorporated by reference.

### BACKGROUND OF THE INVENTION

1. Field of the Invention

The present invention relates to shock absorbers for vehicles. More particularly, the disclosure relates to fluid dampers. More particularly still, the disclosure relates to an apparatus for sealing fluid in a damper.

2. Description of Related Art

Magneto rheological fluid (MR fluid) is a variable character fluid comprising a (e.g. colloid like) suspension of micrometer-sized particles in a carrier fluid, often a type of oil. When subjected to a magnetic field, the fluid greatly increases its apparent viscosity and/or shear strength. The particles, which are typically micrometer or nanometer scale spheres or ellipsoids, are active when subjected to a magnetic field (e.g. such as iron particles) and are distributed randomly and in suspension within the carrier liquid under normal circumstances. When a magnetic field is applied to the liquid suspension, however, the particles (usually in the 0.1-10 μm range) align themselves along lines of magnetic flux. When the fluid is contained between two poles (typically of separation 0.5-2 mm), the resulting chains of particles restrict the movement of the fluid, perpendicular to the direction of flux, effectively increasing its viscosity and/or shear strength. The yield stress of the fluid when it is “activated” or in an “on” magnetized state can be controlled very accurately and quickly (typically a few milliseconds) by varying the magnetic field intensity.

There are problems arising from the use of MR fluids in mechanical applications. For example, maintaining the particulate constituent in proper suspension may be challenging in certain mechanical environments.

What is needed is a damper for a suspension system that utilizes variable rheology fluid in a manner that avoids problems associated with the use of such fluid.

### SUMMARY OF THE INVENTION

In one embodiment, a fluid damper includes a chamber filled with fluid and a barrier separates the chamber into a first and second side. In one embodiment, the barrier is a piston. In another embodiment, the barrier is a valve assembly. The barrier has at least one fluid flow path therethrough and includes at least one seal assembly for selectively sealing the fluid path in a first direction. In one embodiment, the assembly includes a sealing member having at least one non-metallic sealing surface. In one embodiment the non-metallic surface is located on a shim and in another embodiment the non-metallic surface is formed on a seat of the barrier. In another embodiment, the non-metallic surface is provided by a seal ring disposed between a shim and a mating groove in a seat. In one embodiment, the fluid is a magneto-rheological fluid.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only typical embodiments of the invention and are therefore not to be considered limiting of its scope, for the invention may admit to other equally effective embodiments.

FIG. 1 is a perspective view of a bicycle;

FIG. 2 is a cross-section view of a damper in a fork leg;

FIG. 3 is an enlarged view of a valve assembly of the damper of FIG. 2;

FIG. 4 is an enlarged view of an embodiment of a valve assembly of the damper of FIG. 2;

FIG. 5 is one embodiment of a shim stack for use in the damper;

FIG. 6 is a cross-section view of a rear shock absorber;

FIG. 7 is a cross-section view of a piston in a damper of the rear shock absorber during a compression stroke;

FIG. 8 is a cross-section view of the piston in the damper of FIG. 6 during a rebound stroke;

FIG. 9 is a cross-section view of another embodiment of the piston in the rear shock absorber;

FIG. 10 is a cross-section view of another embodiment of a rear shock absorber.

### DETAILED DESCRIPTION

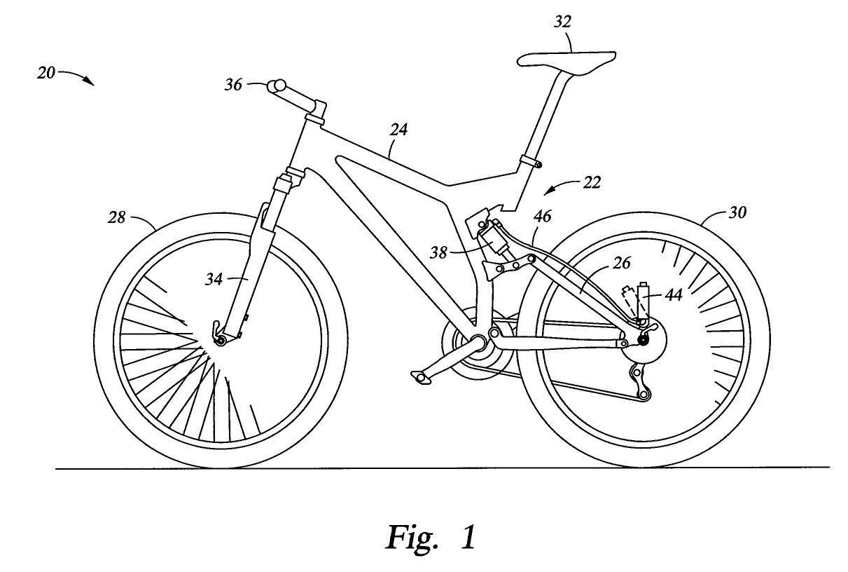

FIG. 1 illustrates an off-road bicycle, or mountain bike 20, including a frame 22 which is comprised of a main frame portion 24 and a swing arm portion 26. The swing arm portion 26 is pivotally attached to the main frame portion 24. The bicycle 20 includes front and rear wheels 28, 30 connected to the main frame 24. A seat 32 is connected to the main frame 24 and provides support for a rider of the bicycle 20.

The front wheel 28 is supported by a suspension fork 34, which is secured to the main frame 24 by a handlebar assembly 36. The rear wheel 30 is connected to the swing arm portion 26 of the frame 22. A rear shock absorber 38 is operably positioned between the swing arm 26 and the main frame 24 to provide resistance to the pivoting motion of the swing arm 26. In one embodiment, the rear shock absorber 38 includes a fluid reservoir 44 hydraulically connected to the main shock body by a hydraulic hose 46. Preferably, the reservoir 44 is connected to the swing arm portion 26 of the bicycle above the hub axis of the rear wheel 30. Suspension members 34, 38 between the front and rear wheels 28, 30 and the frame 22 operate to substantially reduce wheel impact forces from being transmitted to the rider of the bicycle 20.

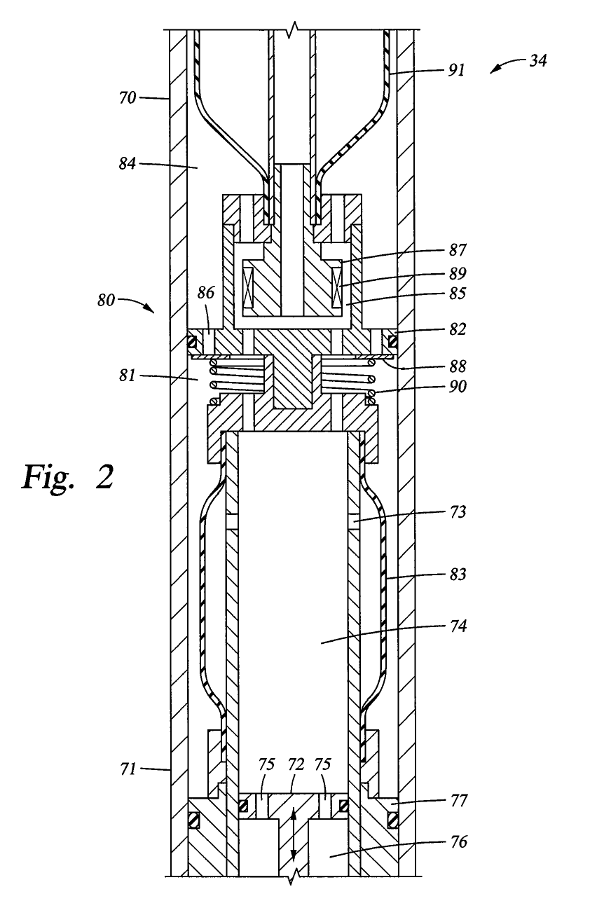

Both the suspension fork 34 and the rear shock absorber 38 may include a damper. FIG. 2 is a cross-section view of one leg of the suspension fork that includes a damper. In one embodiment, the fork leg 70 includes a fork piston 72 that is in a separate axial position from a valve assembly 80, and positioned within an outer housing 71. The fork piston 72 and the valve assembly 80 collectively act as a damper in the fork leg 70. The fork piston 72 moves between a fork compression chamber 74 and a fork rebound chamber 76, and includes at least one piston flow path 75 therethrough for fluid communication between the fork chambers 74, 76. In one embodiment, the fork chambers 74, 76 include hydraulic oil.

The fork piston 72 and the fork chambers 74, 76 are positioned within an outer housing 71. A seal ring 77 surrounds the fork compression and rebound chambers 74, 76, and the width of the seal ring 77 establishes an annular area 81 around the chambers 74, 76. In one embodiment, the annular area 81 includes a damping fluid such as magneto rheological fluid (“MR fluid”), which will be discussed further herein. The seal ring 77 prevents fluid from moving below the seal ring 77. The compression chamber 74 includes one or more ports 73 that lead to a bladder 83 that is positioned within the annular area 81. As the fork piston 72 moves toward the fork compression chamber 74, fluid is moved out through the ports 73 and into the bladder 83, which then expands. As the bladder 83 expands, the MR fluid in the annular area 81 is pushed upward to the valve assembly 80.

A damping fluid is circulated in the annular area 81 and through the valve assembly 80. In one embodiment, the damping liquid is a variable rheology (e.g. viscosity, shear strength) fluid which is an MR fluid. In one embodiment, the fluid comprises particles having magnetic properties, such as iron particles. Typically, the MR fluid is used in conjunction with a magnetized member intended to attract the iron particles in the fluid, thereby enhancing the dampening properties of the fluid at some predetermined location along the damper or at some predetermined time in operation. MR fluid as it is used in a typical MR fluid-type shock absorber is disclosed in U.S. patent application Ser. No. 12/902,239 (“'239 Application”) which Application is incorporated by reference herein in its entirety.

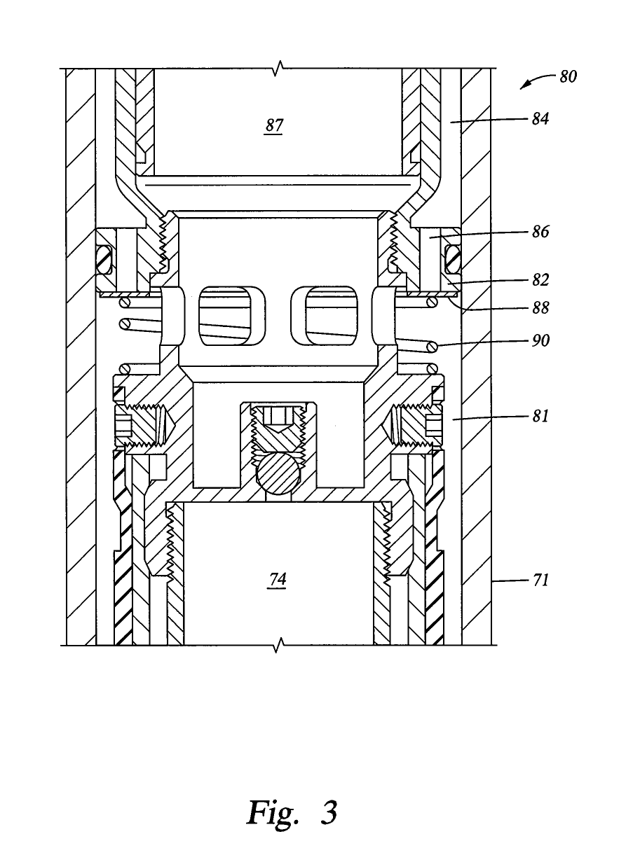

FIG. 3 is an enlarged view of the valve assembly 80. In one embodiment, the valve assembly 80 includes a valve seat 82, a valve member 87, and a valve fluid chamber 84. At least one gap 85 is positioned between the valve seat 82 and the valve member 87 (as shown in FIG. 2), which allows fluid to move from the annular area 81 to the valve fluid chamber 84. In one embodiment, the valve member 87 includes electrical coils that may create a flux as MR fluid moves through the annular gap 85. The valve fluid chamber 84 extends from the valve seat 82 to a second bladder 91, which in one embodiment, may be filled with gas. The valve seat 82 includes one or more valve axial passageways 86, which also provides fluid communication between the valve fluid chamber 84 and the annular area 81.

The valve assembly 80 further includes valve shim stacks 88, which may comprise one or more flexible shims, and may be positioned below the valve seat 82. The valve shim stacks 88 are biased in the closed position against the valve seat 82 by a valve biasing member 90, such as a spring, which is positioned within the annular area 81. The valve shim stacks 88 selectively allow fluid to move from the valve fluid chamber 84 to the annular area 81, and therefore act as one-way check valves.

As pressure by the hydraulic fluid on the bladder 83 is reduced, pressure in the annular area 81 drops. Due to the pressure drop, a higher pressure results in valve fluid chamber 84 which provides enough force on the valve shim stacks 88 to move the valve biasing member 90 away from the valve seat 82. Fluid is thus allowed to move from the valve fluid chamber 84 to the annular area 81.

In one embodiment, the valve assembly 80 includes a seal assembly for selectively sealing the valve axial passageways 86. In one embodiment, the seal assembly may include a non-metallic sealing surface 122 on the valve shim stack 88 helps provide a seal between the valve shim stack 88 and the valve seat 82 when the valve shim stack 88 is in the closed position.

FIG. 5 illustrates an enlarged view of one embodiment of a valve shim stack 88. In FIG. 5, the non-metallic sealing surface 122 acts as the seal assembly for providing a seal between the shim stack 88 and the valve seat 82. The shim stack 88 may be comprised of a composite laminate material. More specifically, the shim stack 88 may be comprised of a metal-elastomer laminate. The metallic surface 124 may include aluminum, steel, titanium, or any other suitable material or combination thereof. The non-metallic surface 122 may include any rubber or other suitable material or combination thereof. In one embodiment, the non-metallic surface 122 is bonded to at least a portion of a face 126 of the shim stack 88 that is comprised of the metallic surface 124, such as steel. The non-metallic surface 122 could be bonded to the metallic surface 124 by an adhesive, could be applied via compression fit, or any other known method of bonding non-metallic elastomers to metals. In one embodiment, the shim stack 88 includes formations 128 for receiving the non-metallic surface 122 and improving a bond therebetween. In one embodiment, the shim stack 88 that is comprised of the metallic surface 124, such as steel, may be completely surrounded by the non-metallic surface 122. The metal-elastomer shim stack 88 is positioned such that the non-metallic surface 122 of the shim stack 112 comes in contact with the valve seat 82 of the valve assembly 80, at least in part, when the shim stack 88 is biased in the closed position. The non-metallic surface 122 acts as a sealing member to seal the shim stack 112 to the valve seat 82 of the valve assembly 80. Other alternate configurations of placing elastomeric or non-metallic material on a metal shim stack are also contemplated, so long as they allow the non-metallic surface 122 of the shim stack 88 to be at least partially positioned on the valve seat 82 of the valve assembly 80.

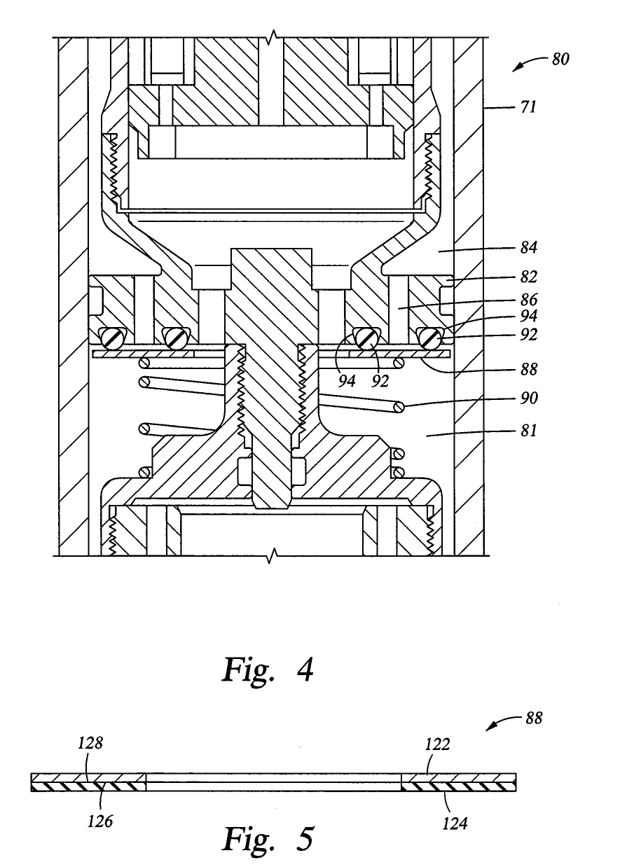

One embodiment of the seal assembly includes a sealing member 92 positioned on the valve seat 82 of the valve assembly 80, as shown in FIG. 4. In FIG. 4, the valve assembly 80 includes one or more mating grooves 94 for receiving the sealing member 92, which may include an elastomeric seal ring such as an o-ring. The elastomeric seal ring is arranged to provide the non-metallic surface 122 on the valve seat 82, and seal an area between the valve shim stack 88 and the valve seat 82 when the shim stack 88 is biased in a closed position. In one embodiment, the sealing member 92 includes a non-metallic sealing surface that may include any suitable elastomer, and the elastomer may be bonded to the entire valve seat 82. In one embodiment, the sealing member may include any suitable elastomer, and may be bonded to a portion of the valve seat 82 where at least a portion of the valve shim stack 88 contacts the valve seat 82.

It is contemplated that the seal assembly of the valve assembly 80 could include a non-metallic sealing surface on the valve shim stack 88, the valve seat 82 of the valve assembly 80, and any combination thereof.

While the foregoing describes the seal assembly of the valve assembly 80, the seal assembly of the valve assembly 80 could be used in dampers associated with shock absorbers 38, or in any other damper assembly using shim stacks 88 to meter fluid flowing through one or more passages through a piston 100.

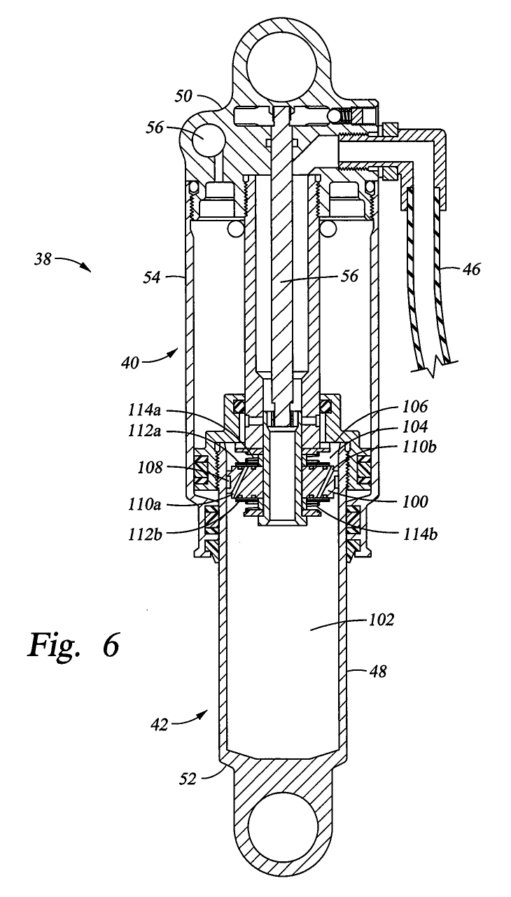

For example, FIG. 6 is a cross-section view of an embodiment of a rear shock absorber. As shown, the shock absorber 38 includes a damper 42 and a gas spring 40 at a first end 50 opposite the damper 42 at a second end 52. The first and second ends 50, 52 are supplied with mounting eyes to connect the shock absorber to different portions of bicycle 20. When the first and second ends 50, 52 move toward each other, the shock absorber undergoes a compression stroke. When the first and second ends 50, 52 move away from each other, the shock absorber undergoes a rebound stroke.

The gas spring 40 of the shock absorber 38 includes an air sleeve 54 that is filled with gas. A fill valve 56 allows a volume of gas within the air sleeve 54 to be adjusted. The gas spring 40 slidingly receives a damper body 48 of the damper 42, which is connected to the first end 50 by a shaft 56 that is fixed within the first end 50. As the shock absorber 38 is compressed, the first and second ends 50, 52 move toward each other, which move the shaft 56 further into the damper body 48. During such compression stroke, the damper 42 is moved into the air sleeve 54, which compresses the gas contained within the gas spring 40. The compressed gas biases the gas spring 40 away from the damper 42 and stores energy, thus is considered a spring. When the shock absorber 38 rebounds from a compression stroke, the damper 42 moves away from the spring 40, and the stored energy in the compressed gas is allowed to expand and push the damper 42 away. Some exemplary air spring configurations are shown in U.S. Pat. No. 6,135,434 (“'434 Patent”) which Patent is entirely incorporated herein by reference.

The damper 42 includes a piston 100 that divides an interior chamber of the damper into a compression chamber 102 and a rebound chamber 104. The compression chamber 102 is defined between the piston 100 and the second end 52 of the shock absorber 38 and decreases in volume during a compression stroke. The rebound chamber 104 is defined between the piston 100 and an upper end 106 of the damper body 48 and decreases in volume during a rebound stroke. The piston 100 includes a seal 108 that is fixed for movement relative to the piston 100, and forms a seal with the inner surface of the damper body 48 as the piston 100 moves between the compression and rebound chambers 102, 104.

A damping liquid is circulated in the compression and rebound chambers 102, 104 of the shock absorber 38. In one embodiment, the damping liquid is a variable rheology (e.g. viscosity, shear strength) fluid which is an MR fluid. In one embodiment, the fluid comprises particles having magnetic properties, such as iron particles.

The piston 100 includes one or more axial passages 110 that allow fluid communication between the compression chamber 102 and the rebound chamber 104. In one embodiment, the piston 100 includes electrical coils that may generate a magnetic flux through the axial passages 110. The piston 100 also includes shim stacks 112 that selectively allow fluid through the axial passages 110. While FIG. 6 shows two passageways 110a, 110b with a shim stack 112a, 112b associated with each, it is contemplated that the piston 100 may include only one passageway and one shim stack. It is also contemplated that the piston 100 may include more than two passageways and shim stacks.

As previously discussed, during a compression stroke, the two ends 50, 52 of the shock absorber 38 move toward each other and the shaft 56 and the piston 100 move into the damper body 48 toward the second end 52 as the damper 42 moves into the air sleeve 54. The compression chamber 102 is compressed by the piston 100, and the fluid in the compression chamber 102 moves through the one or more axial passages 110a, pushes the compression shim stack 112a against a biasing member 114a, such as a spring, and allows fluid to flow into the rebound chamber 104. During a rebound stroke, the shaft 56 and the piston 100 move away from the second end 52 as the damper 42 moves out of the air sleeve 54, and the damping liquid moves from the rebound chamber 104 into axial passage 110b, pushes the rebound shim stack 112b against a biasing member 114b, and allows fluid to flow into the compression chamber 102. The movement of fluid between the compression and rebound chambers 102, 104 provides a dampening effect for the shock absorber 38.

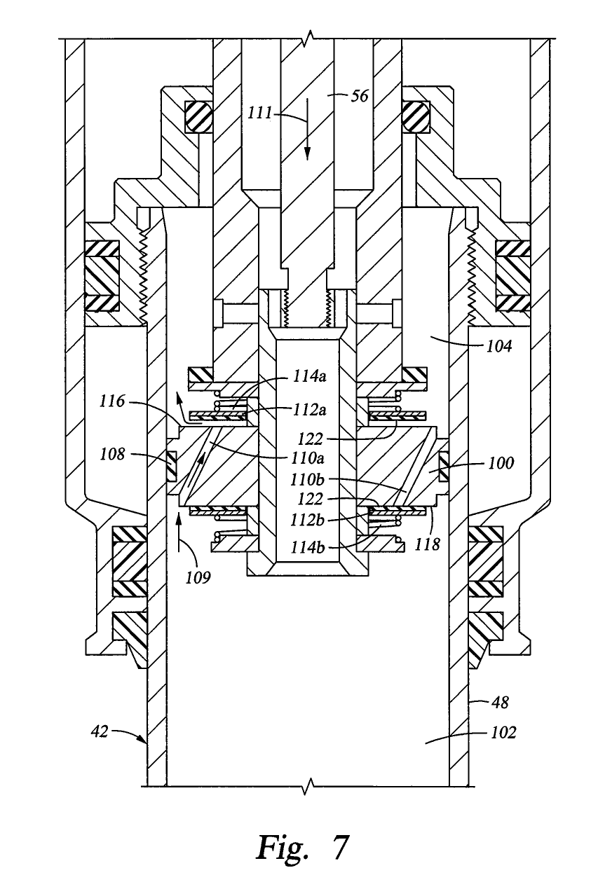

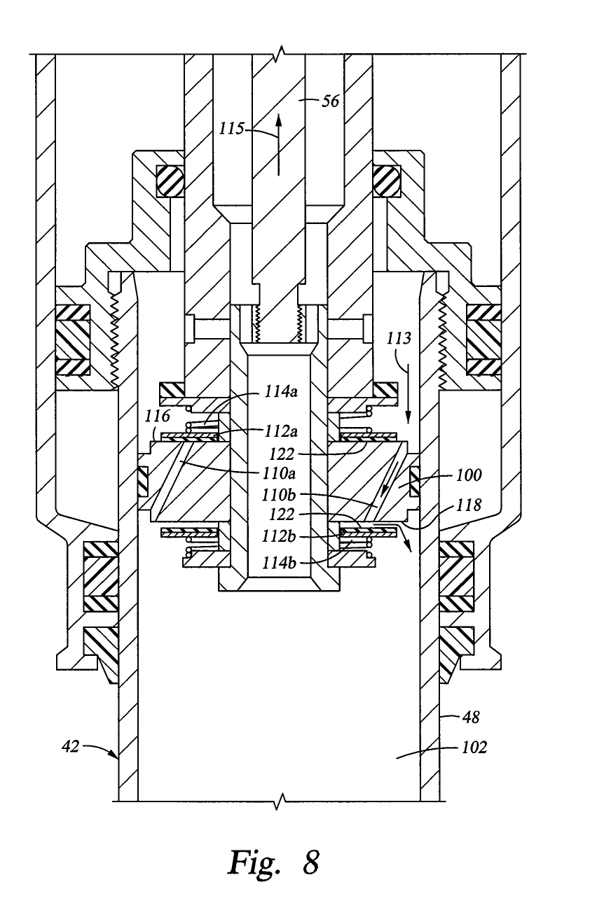

An enlarged view of the piston 100 of the damper 42 during a compression stroke and rebound stroke is shown in FIGS. 7 and 8, respectively. FIG. 7 is a cross-section view of the piston 100 in the damper 42 during a compression stroke. As shown by flow path 109, fluid moves through axial passage 110a and applies pressure against the compression shim stack 112a during a compression stroke, as the shaft 56 moves into the compression chamber 102, as indicated by directional arrow 111. Once a threshold pressure is achieved, the compression shim stack 112a overcomes the biasing force of the spring 114a, moves away from a first seat 116 of the piston, and allows fluid to flow from the compression chamber 102 into the rebound chamber 104. The compression shim stack 112a may comprise one or more flexible shims, and unless the compression shim stack 112a is displaced during a compression stroke, the compression shim stack 112a is usually biased in a closed position on the first seat 116 of the piston 100. In one embodiment, the piston 100 includes a seal assembly for selectively sealing the fluid path through axial passages 110 during a compression and/or rebound stroke. For example, in one embodiment, the seal assembly may include a non-metallic sealing surface 122 on the shim stack 112a to help provide a seal between the shim stack 112a and the first seat 116 when the shim stack 112a is in the closed position.

FIG. 8 is a cross-section view of the piston 100 in the damper 42 during a rebound stroke. As shown by the indicated flow path 113, the fluid moves through axial passage 110b and applies pressure against the rebound shim stack 112b during a rebound stroke, as the shaft 56 moves away from the compression chamber 102, and indicated by directional arrow 115. Once a threshold pressure is achieved, the rebound shim stack 112b, which may also include a non-metallic sealing surface 122, overcomes the biasing force of the spring 114b, moves away from a second seat 118 of the piston 100, and allows fluid to flow from the rebound chamber 104 into the compression chamber 102. The rebound shim stack 112b may also comprise one or more flexible shims, and unless the rebound shim stack 112b is displaced during a rebound stroke, the rebound shim stack 112b is usually biased in a closed position on the second seat 118 of the piston 100. Accordingly, the shim stacks 112a, 112b selectively allow fluid through the passages 110a, 110b of the piston 100 in one direction, and in effect, act as one-way check valves in opposite directions.

In one embodiment, the shim stack illustrated in FIG. 5, and described above, may be used in conjunction with the piston 100 of the shock absorber 38. In one embodiment, the metal-elastomer shim stack 112 is positioned such that the non-metallic surface 122 of the shim stack 112 comes in contact with the first or second seat 116, 118 of the piston 100, at least in part, when the shim stack 112 is biased in the closed position. The non-metallic surface 122 acts as a sealing member to seal the shim stack 112 to the first or second seat 116, 118 of the piston 100. Other alternate configurations of placing elastomeric or non-metallic material on a metal shim stack are also contemplated, so long as they allow the non-metallic surface 122 of the shim stack 112a, 112b to be positioned, at least in part, on the first or second seats 116, 118 of the piston 100.

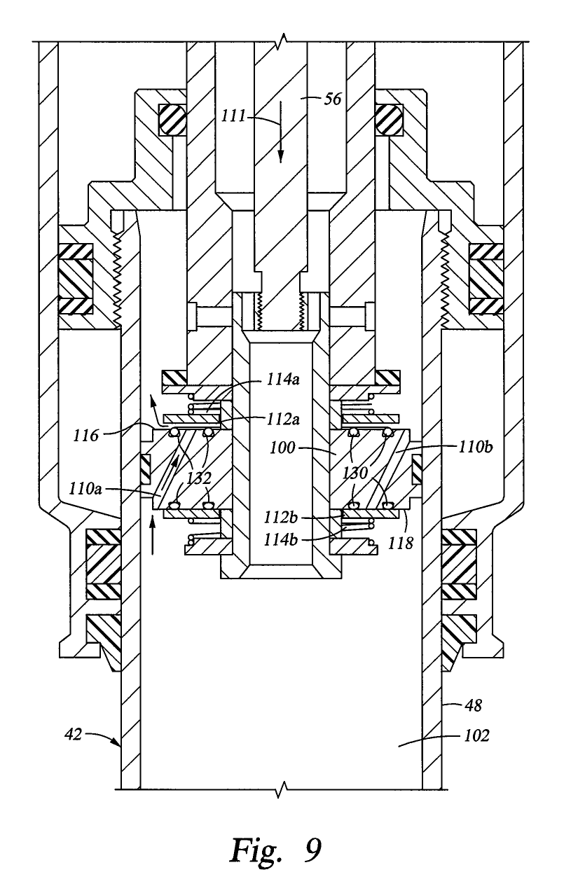

One embodiment of the seal assembly includes a sealing member positioned on the first and/or second seats 116, 118 of the piston 100, as shown in FIG. 9. In FIG. 9, the piston 100 includes one or more mating grooves 130 for receiving the second sealing member, which may include an elastomeric seal ring 132, such as an o-ring. The elastomeric seal ring 132 is arranged to seal an area between the shim stack 112 and the first and/or second seats 116, 118 when the shim stack is biased in a closed position. In one embodiment, the sealing member includes a non-metallic sealing surface that may include any suitable elastomer, and the elastomer may be bonded to the entire first and/or second seats 116. In one embodiment, the sealing member may include any suitable elastomer, and may be bonded to a portion of the first and/or second seats 116, 118 where at least a portion of the shim stack 112 contacts the first and/or second seats 116, 118.

It is contemplated that the seal assembly of the piston 100 could include a non-metallic sealing surface on the shim stack 112, the seats 116, 118 of the piston 100, and any combination thereof.

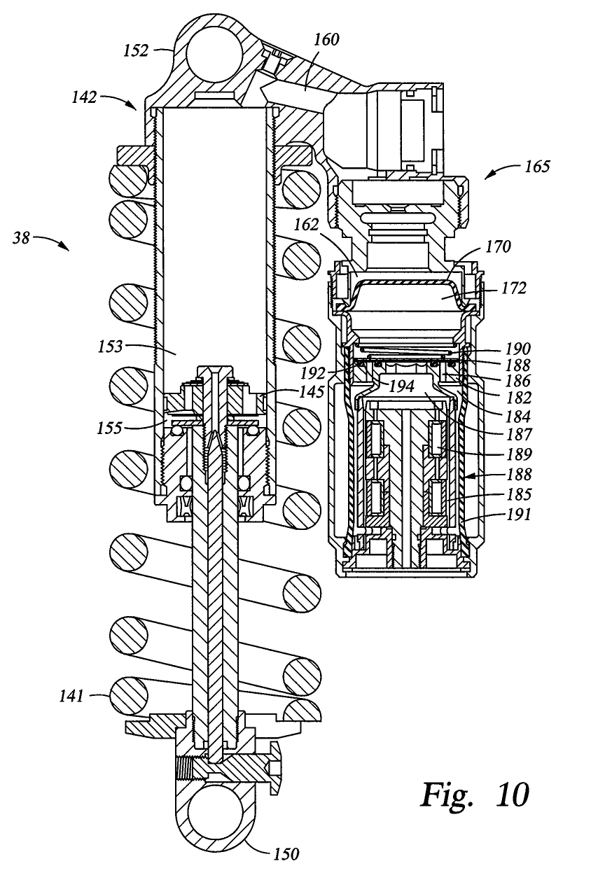

FIG. 10 shows another embodiment of a rear shock absorber. The shock absorber 38 includes a coil spring 141 at a first end 150 and a damper 142 at a second end 152. As the first and second ends 150, 152 move toward each other, the coil spring 141 is compressed and moves a piston 145 from a rebound chamber 155 to a compression chamber 153. The rebound and compression chambers 153, 155 contain damping fluid, and in one embodiment, the damping fluid is hydraulic oil. As the piston 145 moves into the compression chamber 153, the damping fluid moves through a passageway 160 into a first reservoir chamber 162 in a reservoir 165.

A bladder 170 seals the first reservoir chamber 162 from a second reservoir chamber 172, which may include a second damping fluid. In one embodiment, the second damping fluid is a variable rheological fluid such as MR fluid. As the damping fluid moves into the first reservoir chamber 162, pressure is applied to the bladder 170, which in turn moves the second damping fluid toward a valve assembly 180.

In one embodiment, the valve assembly 180 includes a valve seat 182, a valve member 187, and a valve fluid chamber 184. At least one gap 185 is positioned between the valve seat 182 and the valve member 187, which allows fluid to move from the second reservoir chamber 172 to the valve fluid chamber 184. In one embodiment, the valve member 187 includes electrical coils 189 that may create a flux as MR fluid moves through the annular gap 185. The valve fluid chamber 184 extends from the valve seat 182 to a second bladder 191, which in one embodiment, may be filled with gas. The valve seat 182 includes one or more valve axial passageways 186, which also provides fluid communication between the valve fluid chamber 184 and the second reservoir chamber 172.

The valve assembly 180 further includes valve shim stacks 188, which may comprise one or more flexible shims, and may be positioned below the valve seat 182. The valve shim stacks 188 are biased in the closed position against the valve seat 182 by a valve biasing member 190, such as a spring, which is positioned within the second reservoir chamber 172. The valve shim stacks 188 selectively allow fluid to move from the valve fluid chamber 184 to the second reservoir chamber 172, and therefore act as one-way check valves.

As pressure by the damping fluid on the bladder 170 is reduced, pressure in the second reservoir chamber 172 drops. Due to the pressure drop, a higher pressure results in valve fluid chamber 184 which provides enough force on the valve shim stacks 188 to move the valve biasing member 190 away from the valve seat 182. Fluid is thus allowed to move from the valve fluid chamber 184 to the second reservoir chamber 172.

In one embodiment, the valve assembly 180 includes a seal assembly for selectively sealing the valve axial passageways 186. In one embodiment, the seal assembly may include a non-metallic sealing surface 122 on the valve shim stack 188 to help provide a seal between the valve shim stack 188 and the valve seat 182 when the valve shim stack 188 is in the closed position.

In one embodiment, the shim stack illustrated in FIG. 5, and described above, may be used in conjunction with the valve assembly 180. In one embodiment, the metal-elastomer shim stack 188 is positioned such that the non-metallic surface 122 of the shim stack 188 comes in contact with the valve seat 182 of the valve assembly 180, at least in part, when the shim stack 188 is biased in the closed position. The non-metallic surface 122 acts as a sealing member to seal the shim stack 112 to the valve seat 182 of the valve assembly 180. Other alternate configurations of placing elastomeric or non-metallic material on a metal shim stack are also contemplated, so long as they allow the non-metallic surface 122 of the shim stack 188 to be at least partially positioned on the valve seat 182 of the valve assembly 180.

One embodiment of the seal assembly includes a sealing member 192 positioned on the valve seat 182 of the valve assembly 180, as shown in FIG. 10. In FIG. 10, the valve assembly 180 includes one or more mating grooves 194 for receiving the sealing member 192, which may include an elastomeric seal ring such as an o-ring. The elastomeric seal ring is arranged to seal an area between the valve shim stack 188 and the valve seat 182 when the shim stack 188 is biased in a closed position. In one embodiment, the second sealing member 192 includes a non-metallic sealing surface that may include any suitable elastomer, and the elastomer may be bonded to the entire valve seat 182. In one embodiment, the second sealing member may include any suitable elastomer, and may be bonded to a portion of the valve seat 182 where at least a portion of the valve shim stack 188 contacts the valve seat 182.

It is contemplated that the seal assembly of the valve assembly 180 could include a non-metallic sealing surface on the valve shim stack 188, the valve seat 182 of the valve assembly 180, and any combination thereof.

The forgoing illustrates various apparatuses and methods of obtaining a better seal between the shim stack 88, 112, 188 and the seat 82, 182 of a valve assembly 80 or the seats 116, 118 of the piston 100. Because a better seal is formed between the shim stack 88, 112, 188 and the seats 82, 116, 118, 188, variable rheology fluid is prevented from leaking through the seal. Accordingly, because the variable rheology fluid is prevented from leaking through the seal, particles, such as iron particles contained in the rheology fluid, is not filtered out of the fluid. For example, without the sealing elements described above, it is possible for the base fluid to escape through the shim stack, leaving iron particles behind. Furthermore, it is also contemplated that the seal assembly described above could be used to address problems in other fluids, such as electrorheological fluid. Accordingly, the foregoing addresses problems associated with using variable rheology fluids in mechanical systems.

While the foregoing is directed to embodiments of the invention, other and further embodiments of the invention may be devised without departing from the basic scope thereof, and the scope thereof is determined by the claims that follow.

1. A fluid damper comprising:
a chamber filled with a fluid, the fluid comprising a variable rheological fluid;
a piston separating the chamber into a compression side and a rebound side and including at least one fluid flow path therethrough, and
a valve assembly disposed in the chamber and axially displaced from the piston, the valve assembly including at least one seal assembly for selectively sealing a valve fluid flow path through the valve assembly in a first direction, the seal assembly including a sealing member having at least one non-metallic sealing surface.

2. The fluid damper of claim 1, wherein the sealing member is at least one shim constructed and arranged to selectively seal against a valve seat.

3. The fluid damper of claim 2, wherein the non-metallic sealing surface comprises an elastomer in at least the area of the shim that contacts the valve seat.

4. The fluid damper of claim 1 wherein the sealing member having at least one non-metallic sealing surface is a valve seat constructed and arranged to receive a shim in a sealing relationship.

5. The fluid damper of claim 1, wherein the seal assembly includes a second sealing member that also includes a non-metallic sealing surface.

6. The fluid damper of claim 5, wherein the first sealing member is a shim and the second sealing member is a valve seat.

7. The fluid damper of claim 1, wherein the non-metallic surface comprises an elastomeric seal ring constructed and arranged to seal an area between a shim and a valve seat when the shim is in a closed position.

8. The fluid damper of claim 9, wherein the ring is disposed in a mating groove formed between the shim and the valve seat.

9. A fluid damper comprising:
a chamber filled with a fluid, the fluid comprising a variable rheological fluid; and
a piston separating the chamber into a compression side and a rebound side and including at least one fluid flow path therethrough, the piston further including at least one seal assembly for selectively sealing the fluid flow path through the piston in a first direction, the seal assembly including a sealing member having at least one non-metallic sealing surface.

10. The fluid damper of claim 9, wherein the sealing member is at least one shim constructed and arranged to selectively seal against a seat.

11. The fluid damper of claim 10, wherein the non-metallic sealing surface comprises an elastomer in at least the area of the shim that contacts the seat.

12. The fluid damper of claim 9 wherein the sealing member having at least one non-metallic sealing surface is a seat constructed and arranged to receive a shim in a sealing relationship.

13. The fluid damper of claim 9, wherein the seal assembly includes a second sealing member that also includes a non-metallic sealing surface.

14. The fluid damper of claim 13, wherein the first sealing member is a shim and the second sealing member is a seat.

15. The fluid damper of claim 9, wherein the non-metallic surface comprises an elastomeric seal ring constructed and arranged to seal an area between a shim and a seat when the shim is in a closed position.

16. A fluid damper comprising:
a chamber filled with fluid, the fluid comprising a variable rheological fluid; and
a barrier that separates the chamber into a first side and a second side and includes at least one fluid flow path therethrough, the barrier further including at least one seal assembly for selectively sealing the fluid flow path in a first direction, the seal assembly including a sealing member having at least one non-metallic sealing surface.

17. The fluid damper of claim 16, wherein the sealing member is at least one shim constructed and arranged to selectively seal against a barrier seat.

18. The fluid damper of claim 17, wherein the non-metallic sealing surface comprises an elastomer in at least the area of the shim that contacts the barrier seat.

19. The fluid damper of claim 16 wherein the sealing member having at least one non-metallic sealing surface is a barrier seat constructed and arranged to receive a shim in a sealing relationship.

20. The fluid damper of claim 19, wherein the non-metallic surface comprises an elastomeric seal ring constructed and arranged to seal an area between a shim and the barrier seat when the shim is in a closed position.
